(19) United States
(12) Patent Application Publication
(10) Pub. No.: US 2016/0268799 A1
(43) Pub. Date: Sep. 15, 2016

(54) CONTROL DEVICE AND CONTROL METHOD FOR VEHICLE OPEN-CLOSE MEMBER, AND VEHICLE OPEN-CLOSE MEMBER INCLUDING THE CONTROL DEVICE

(71) Applicant: AISIN SEIKI KABUSHIKI KAISHA, Kariya-shi, Aichi (JP)

(72) Inventors: Hiroshi URASE, Kariya-shi (JP); Yasuhiro YOKOI, Kariya-shi (JP); Yuya ABO, Kariya-shi (JP); Takeshi NISHIKIBE, Kariya-shi (JP); Toshiro MAEDA, Kariya-shi (JP)

(73) Assignee: AISIN SEIKI KABUSHIKI KAISHA, Kariya-shi, Aichi-ken (JP)

(21) Appl. No.: 15/032,524

(22) PCT Filed: Sep. 17, 2014
(86) PCT No.: PCT/JP14/04792

§ 371 Date: Apr. 27, 2016

(30) Foreign Application Priority Data
Oct. 29, 2013 (JP) 2013-224066

(51) Int. Cl. H02H 7/08; E05F 15/60

(52) U.S. Cl. CPC H02H 7/0844; E05F 15/60; E05Y 2400/30; E05Y 2900/531

(57) ABSTRACT

A control device for a vehicle open-close member includes an input circuit configured to receive an inputted voltage signal indicating a drive voltage, a power supply voltage and the drive voltage being respectively applied to one terminal and another terminal of an open-close motor of a vehicle open-close member; a short-circuit state judgement unit configured to judge a short circuit as occurring if the drive voltage is out of a predetermined range; and an output circuit configured to output a control signal for decreasing a voltage to be applied to the open-close motor, if the short circuit is judged as occurring.

### TECHNICAL FIELD

The present invention relates to a control device and control method for a vehicle open-close member, which are capable of implementing fail-safe control, and a vehicle open-close member including the control device.

### BACKGROUND ART

There is known a vehicle open-close member capable of performing automatic open-close operations by means of a motor. Patent Document 1 discloses a driver circuit 2 configured to operate a motor 1 and including an FET 3, a pre-driver circuit 5, a CPU 4, a state detection circuit 6, and a pre-driver circuit state detection circuit 7 (see FIGS. 1 and 8 in Patent Document 1). The driver circuit 2 performs pulse width modulation (PWM) control of the motor by applying a PWM signal outputted from the CPU 4 to the gate terminal of the FET 3 via the pre-driver circuit 5.

The state detection circuit 6 measures a voltage at the drain terminal of the FET 3, while the pre-driver circuit state detection circuit 7 measures a voltage to be inputted to the gate terminal of the FET 3. The CPU 4 detects a failure in the FET 3 and transistors inside the pre-driver circuit 5 by comparing the voltage measured by the state detection circuit 6 and the voltage measured by the pre-driver circuit state detection circuit 7. In a case where the driver circuit 2 including such a failure detection mechanism is applied to a motor for a vehicle open-close member, the motor can be controlled to stop at the occurrence of a failure in any of the FET 3 and the transistors inside the pre-driver circuit 5, and therefore may be prevented from performing an operation despite the intension of an operator.

### CITATION LIST

Patent Document

Patent Document 1: Japanese Patent Application Laid-Open No. 2005-295655

### SUMMARY OF INVENTION

### Technical Problem

In the case of the driver circuit 2 disclosed in Patent Document 1, the driver circuit 2, the motor 1, a power supply source, and other elements are connected by way of wires. These wires are disposed in an environment inside the vehicle to which large stress is applied by a temperature change, vibration, humidity, load, and so on. Accordingly, a short circuit may occur between wires due to causes such as a deterioration of the insulating coating on the wires, separation of the connect portions of the wires, and breaks of the wires. In addition, for the same reason, a short circuit may also occur between any of the wires and the vehicle body having a ground potential. Also when a short circuit occurs due to such a cause, the motor may malfunction. For example, if a short circuit occurs while the open-close member is opened, the motor may malfunction to cause the open-close member to perform a close operation despite the intention of a user. However, the driver circuit 2 disclosed in Patent Document 1 is not provided with means for detecting a short circuit, nor a control means for preventing a malfunction.

In addition, according to Patent Document 1, the CPU 4 controls the electric power to be applied to the motor 1 by applying the PWM signal to the FET 3 of the pre-driver circuit 5. In this case, if the wire connecting the FET 3 and the motor 1, for example, is short-circuited to the ground, the high electric power is applied to the motor 1. This may cause a malfunction in which the open-close member performs a high-speed open operation or close operation. In this regard, there is a demand for a vehicle open-close member including a control device that detects a short circuit at the occurrence of the short circuit, and prevents a malfunction.

The present invention has been made in view of the problems described above, and has an object to provide a control device for a vehicle open-close member, the control device being capable of performing short-circuit detection when a short circuit occurs in any of wires connecting an amplifier circuit, an open-close driver device, a power supply source, and other elements, and keeping the open-close member from malfunctioning.

### Solution to Problem

One aspect of the present invention provides control device for a vehicle open-close member including: an input circuit configured to receive an inputted voltage signal indicating a drive voltage, a power supply voltage and the drive voltage being respectively applied to one terminal and another terminal of an open-close motor of a vehicle open-close member; a short-circuit state judgement unit configured to judge a short circuit as occurring if the drive voltage is out of a predetermined range; and an output circuit configured to output a control signal for decreasing a voltage to be applied to the open-close motor, if the short circuit is judged as occurring.

### Advantageous Effects of Invention

The vehicle state detection device provided according to the one aspect of the present invention is capable of performing short-circuit detection when a short circuit occurs in any of wires connecting an amplifier circuit, an open-close driver device, a power supply source, and other elements to each other, and keeping the open-close member from malfunctioning.

### BRIEF DESCRIPTION OF DRAWINGS

FIG. 1 is a schematic side view of a vehicle according to an embodiment of the present invention.

FIG. 2A is a schematic structural view of a slide door according to the embodiment of the present invention.

FIG. 2B is a schematic cross sectional view of an open-close driver device according to the embodiment of the present invention.

FIG. 3 is a block diagram of a control device for a vehicle open-close member according to the embodiment of the present invention.

FIG. 4 is a diagram illustrating a circuit configuration of the control device according to the embodiment of the present invention.

FIG. 5A is a diagram illustrating a waveform of a PWM signal.

FIG. 5B is a diagram illustrating a waveform of a PWM signal with a high duty ratio.

FIG. 6 is a diagram presenting a gate voltage, a detected voltage, and a motor rotational speed in the circuit configuration according to the embodiment of the present invention.

FIG. 7 is a diagram presenting the gate voltage, the detected voltage, and the motor rotational speed in a short circuit case 1 in the circuit configuration according to the embodiment of the present invention.

FIG. 8 is a diagram presenting the gate voltage, the detected voltage, and the motor rotational speed in a short circuit case 2 in the circuit configuration according to the embodiment of the present invention.

FIG. 9 is a diagram presenting the gate voltage, the detected voltage, and the motor rotational speed in a short circuit case 3 in the circuit configuration according to the embodiment of the present invention.

FIG. 10 is a diagram presenting the gate voltage, the detected voltage, and the motor rotational speed in a short circuit case 4 in the circuit configuration according to the embodiment of the present invention.

FIG. 11 is a diagram presenting the gate voltage, the detected voltage, and the motor rotational speed in a short circuit case 5 in the circuit configuration according to the embodiment of the present invention.

FIG. 12 is a diagram presenting the gate voltage, the detected voltage, and the motor rotational speed in short circuit cases 6 and 8 in the circuit configuration according to the embodiment of the present invention.

FIG. 13 is a diagram presenting the gate voltage, the detected voltage, and the motor rotational speed in a short circuit case 7 in the circuit configuration according to the embodiment of the present invention.

FIG. 14 is a control flowchart of the control device for the vehicle open-close member according to the embodiment of the present invention.

FIG. 15 is a control flowchart of a control device for a vehicle open-close member according to a modification of the present invention.

### DESCRIPTION OF EMBODIMENTS

Hereinafter, an exemplary embodiment for carrying out the present invention is explained in detail with reference to the drawings. It should be noted that dimensions, materials, shapes, relative positions of component elements, and any other things described in the following embodiment are optional ones, and can be altered depending on a structure or various conditions of a device to which the present invention is applied. Moreover, unless otherwise stated, the scope of the present invention should not be limited to modes specifically described in detail in the following embodiment. In addition, component elements having the same function are assigned with the same reference numeral in the drawings explained below, and repetitive explanations thereof are omitted in some cases.

### <Structure of Vehicle>

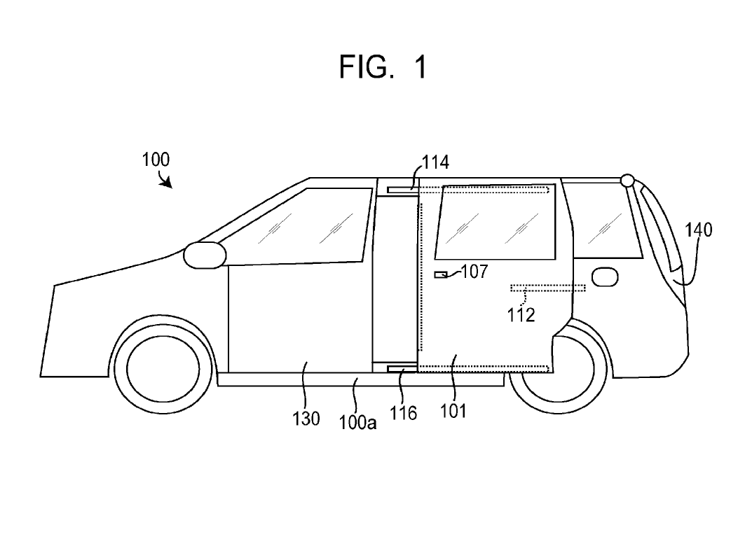

FIG. 1 is a schematic side view of a vehicle 100 according to an embodiment of the present invention. The vehicle 100 includes a slide door 101 as a vehicle open-close member. The slide door 101 includes an open-close mechanism to be driven by electric power, and is supported on a center rail 112, an upper rail 114, and a lower rail 116 in such a manner that the slide door 101 can move relative to a vehicle body 100a in front-rear directions of the vehicle 100. Note that the vehicle open-close member is not limited to the slide door 101, but may be a swing door 130 or a back door 140.

### <Structure of Vehicle Open-Close Member>

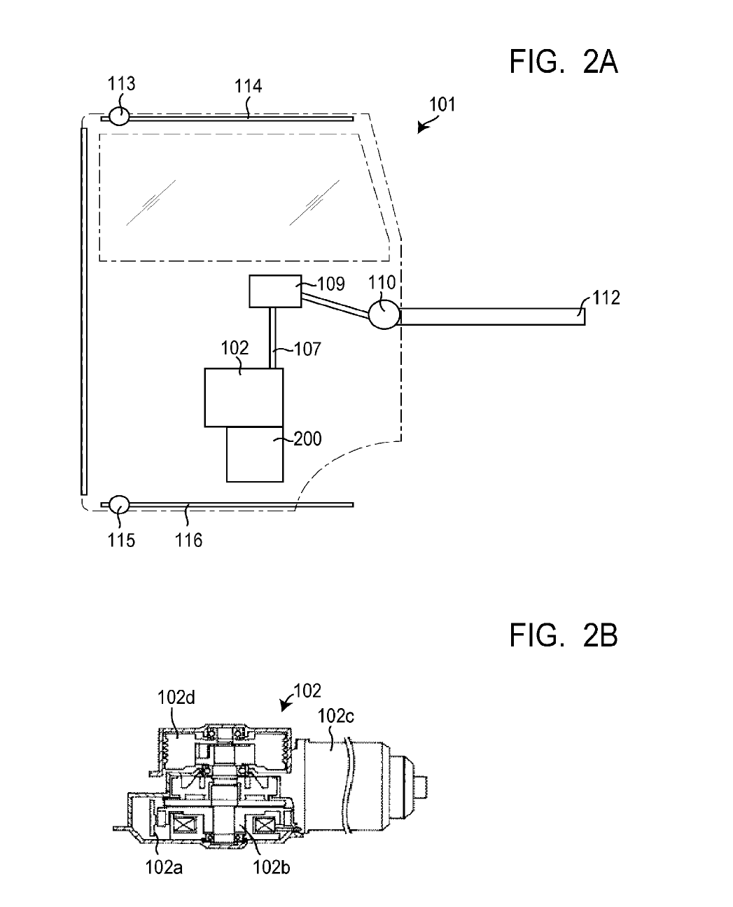

FIG. 2A is a schematic structural view of the slide door 101 as the vehicle open-close member, and FIG. 2B is a schematic cross sectional view of an open-close driver device 102. The structure of the slide door 101 is described below in detail.

The open-close driver device 102 and an electronic control unit (ECU) 200 are attached to the slide door 101. It should be noted that a place to which the ECU 200 is attached is not limited to the slide door 101, but may be any desired place inside the vehicle 100.

The slide door 101 is supported on the center rail 112, the upper rail 114, and the lower rail 116 via a center roller 110, an upper roller 113, and a lower roller 115, respectively, in such a manner as to be movable in the front-rear directions of the vehicle 100.

The ECU 200 inverts the polarity of a voltage to be applied to an open-close motor 102c by controlling a relay inside an output circuit connected to the open-close driver device 102. With this operation, the rotation direction of the open-close motor 102c is changed, and the open/close direction of the slide door 101 is controlled. Here, when an electromagnetic clutch 102b is in a disengaged state, in other words, a disconnected state, a user can open or close the slide door 101 manually.

A pulse sensor 102a is a hall element or the like, and outputs a pair of pulse signals out of phase from each other to the ECU 200. The ECU 200 is able to detect a rotation amount, a rotational speed, and a rotation direction of the open-close motor 102c based on the pulse signals, and to judge a position, a moving speed and a moving direction of the slide door 101.

As illustrated in FIG. 2B, the open-close driver device 102 includes a driving mechanism including the pulse sensor 102a, the electromagnetic clutch 102b, the open-close motor 102c, and a drum 102d. One end of a cable 107 is fixed to the drum 102d, while the other end of the cable 107 is fixed to the vehicle body 100a with the cable 107 guided through a guide pulley 109 and the center rail 112. With this structure, the ECU 200 brings the electromagnetic clutch 102b into engagement, i.e., turns the electromagnetic clutch 102b into the connected state, and drives the open-close motor 102c. By this operation, the motive power of the open-close motor 102c is transmitted to the slide door 101 via the electromagnetic clutch 102b, the drum 102d, and the cable 107. In this way, the open-close driver device 102 is capable of opening and closing the slide door 101 by driving according to control signals outputted from the ECU 200.

### <Structure of Control Device for Vehicle Open-Close Member>

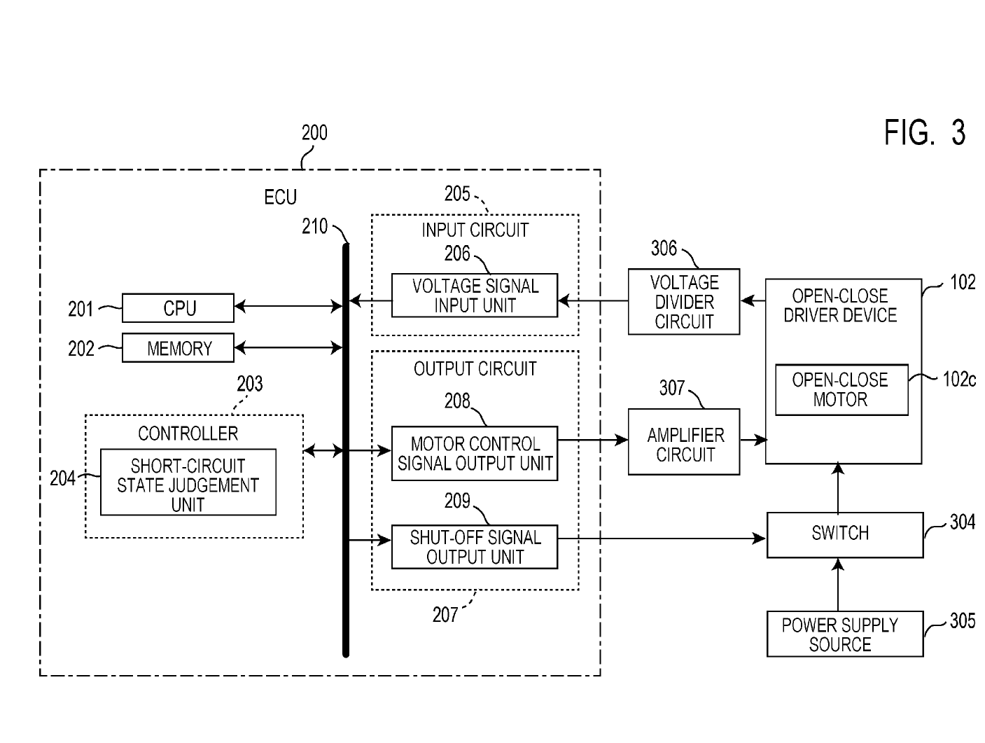

FIG. 3 is a block diagram of the ECU 200 as a control device for the vehicle open-close member, and others. Hereinafter, the structure of the ECU 200 as the control device for a vehicle open-close member is described in detail.

The ECU 200 includes a central processing unit (CPU) 201, a memory 202, a controller 203, an input circuit 205, an output circuit 207, and a system bus 210. The controller 203 has predetermined functions to process signals inputted to the ECU 200 and control the open-close driver device 102 and a switch 304 in collaboration with the CPU 201 and the memory 202. Here, the controller 203 may be a software program stored inside the memory 202 and having the functions to be executed by the CPU 201 written therein, or be a hardware element mounted inside the ECU 200. In addition, the ECU 200 may further include hardware elements such as a counter circuit and an oscillator to provide a clock frequency to the CPU 201.

The controller 203 includes a short-circuit state judgement unit 204. The component elements in the ECU 200 exchange signals with each other via the system bus 210.

The CPU 201 performs computation processes to implement predetermined functions, while the memory 202 includes a read only memory (ROM) for storing programs, a random access memory (RAM) for temporary storage, and the like.

The input circuit 205 receives a voltage signal (a voltage signal indicating a drive voltage) inputted from the open-close driver device 102 via a voltage divider circuit 306. The input circuit 205 includes a voltage signal input unit 206. The voltage signal input unit 206 converts the inputted voltage signal into a digital signal processable by the CPU 201. The voltage divider circuit 306 divides the voltage signal from the open-close driver device 102 at a predetermined ratio, thereby converting the voltage of the voltage signal to a voltage (for example 0 to 5 V) suitable to processing by the CPU 201.

The output circuit 207 includes a motor control signal output unit 208 and a shut-off signal output unit 209. The motor control signal output unit 208 converts a signal inputted via the system bus 210 into an analog signal, and outputs the analog signal as a control signal to the open-close driver device 102 via an amplifier circuit 307. The amplifier circuit 307 amplifies the control signal outputted from the motor control signal output unit 208 to a predetermined voltage (for example, 0 to 12 V) suitable to control of the open-close motor 102c. The shut-off signal output unit 209 outputs a control signal for switch-opening/closing to the switch 304, and thereby switches connection and disconnection between the open-close driver device 102 and a power supply source 305.

Based on the signal outputted from the open-close driver device 102, the short-circuit state judgement unit 204 judges whether or not a circuit inside the open-close driver device 102 is short-circuited to any of the power supply source and the switch.

The controller 203 outputs control signals for controlling the open-close motor 102c and the switch 304 based on the judgment result in the short-circuit state judgement unit 204, to the open-close motor 102c and the switch 304, respectively. The open-close motor 102c and the switch 304 perform predetermined operations based on the control signals outputted from the ECU 200.

### <Driver Circuit Configuration of Vehicle Open-Close Member>

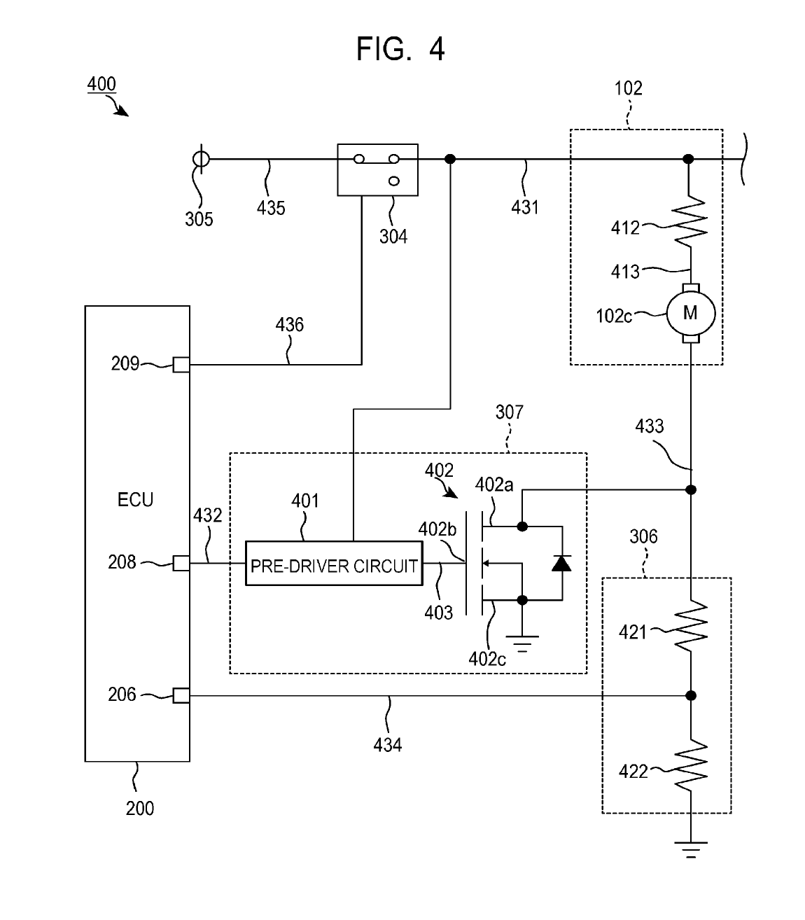

FIG. 4 illustrates a driver circuit 400 of the vehicle open-close member of the present embodiment. A circuit configuration for driving the vehicle open-close member is described by using FIG. 4. The driver circuit 400 includes the ECU 200 as the control device of the vehicle open-close member, the open-close driver device 102, the switch 304, the power supply source 305, the voltage divider circuit 306, and the amplifier circuit 307.

The ECU 200 includes the voltage signal input unit 206, the motor control signal output unit 208, and the shut-off signal output unit 209. The amplifier circuit 307 is connected to the motor control output unit 208 of the ECU 200 via a wire 432. The amplifier circuit 307, the open-close driver device 102, and the voltage divider circuit 306 are connected to each other via a wire 433. The voltage divider circuit 306 is connected to the voltage signal input unit 206 of the ECU 200 via a wire 434. The wires 432, 433, 434, and so on constitute electric wiring for use to supply electric power and to transmit and receive electric signals. In the present specification, it should be noted that the term “wire” includes all kinds of electric wiring, and for example, includes a cable, a connector connecting cables, a fixing tool such as a clip, and a wire harness formed of an assembly of them, as well as electrode patterns in a semiconductor device and on a print circuit board.

The motor control signal output unit 208 transmits a PWM signal for driving the vehicle open-close member to the amplifier circuit 307. The amplifier circuit 307 includes a pre-driver circuit 401 and a FET 402. The pre-driver circuit 401 is connected to the motor control signal output unit 208 of the ECU 200 via the wire 432, and is connected to the FET 402 via a wire 403. The pre-driver circuit 401 is a circuit that amplifies the PWM signal received from the ECU 200 and outputs the amplified signal to the FET 402, and includes, for example, a transistor and so on. The pre-driver circuit 401 is connected to a wire 431 to which a power supply voltage is applied, and is supplied with electric power necessary for amplification from the wire 431. The FET 402 is an n-channel metal-oxide-semiconductor field effect transistor (MOSFET), and includes a drain terminal 402a, a gate terminal 402b, and a source terminal 402c. The gate terminal 402b is connected to the pre-driver circuit 401 via the wire 403, and receives the amplified PWM signal. The source terminal 402c is connected to the ground. The drain terminal 402a is connected to the open-close driver device 102 and the input circuit 214 via the wire 433. In addition, a diode is provided between the drain terminal 402a and the source terminal 402c, the diode configured to protect the FET 402 from a counter electromotive force of the open-close motor 102c.

The voltage signal input unit 206 has a function to acquire a voltage at the wire 434 as an electric signal in order to detect a short circuit in the driver circuit 400. This function may be implemented, for example, by processing a digital signal to which the voltage at the wire 434 is converted by an A/D converter provided inside the voltage signal input unit 206.

The voltage divider circuit 306 includes a resistor 421 and a resistor 422. One terminal of the resistor 421 is connected to the amplifier circuit 307 and the open-close driver device 102 via the wire 434, and the other terminal of the resistor 421 is connected to the voltage signal input unit 206 and one terminal of the resistor 422 via the wire 434. The other terminal of the resistor 422 is connected to the ground. Here, V₄₃₃ denotes the voltage at the wire 433; R₄₂₁, the resistance value of the resistor 421; and R₄₂₂, the resistance value of the resistor 422.

Then, the voltage V₄₃₄ at the wire 434 is V₄₃₄=V₄₃₃·R₄₂₂/(R₄₁₄+R₄₂₂). Thus, the voltage at the wire 434 is applied to the voltage signal input unit 206 after being divided by the voltage divider circuit 306 at a predetermined ratio. For example, if a maximum voltage that may be applied to the wire 433 is 12 V while a maximum voltage that can be inputted to the voltage signal input unit 206 is 5 V, the values R₄₂₁ and R₄₂₂ are selected such that R₄₂₂/(R₄₁₁+R₄₂₂) is equal to or less than 5/12. This voltage division may inhibit a problem such as erroneous measurement of the voltage inputted to the voltage signal input unit 206 because the voltage exceeds the maximum voltage.

The open-close driver device 102 includes the open-close motor 102c and a resistor 412. One terminal of the open-close motor 102c is connected to the resistor 412 via a wire 413, and the other terminal of the open-close motor 102c is connected to the amplifier circuit 307 and the voltage divider circuit 306 via the wire 433. The resistor 412 is supplied with the power supply voltage via the wire 431. When the open-close motor 102c is supplied with the voltage, the open-close motor 102c supplies the motive power to the slide door 101 of the vehicle 100, and the slide door 101 performs the open operation or the close operation.

The power supply source 305 provided in the vehicle 100 is connected to the switch 304 via a wire 435. The switch 304 is connected to the open-close driver device 102 via the wire 431. The switch 304 includes, for example, an electromagnetic relay, a FET switch, or the like, and switches the connection and the disconnection between the wire 435 and the wire 431. The open-close motor 102c is supplied with the electric power when the switch 304 is closed, and is not supplied with the electric power when the switch 304 is opened. The switching of the switch 304 is performed according to the signal received from the shut-off signal output unit 209 of the ECU 200 via a wire 436. As the power supply source 305, used is a rechargeable battery such as a lead storage battery which supplies a DC voltage at about 12 V, for example.

### <Circuit Operation of Vehicle Open-Close Member>

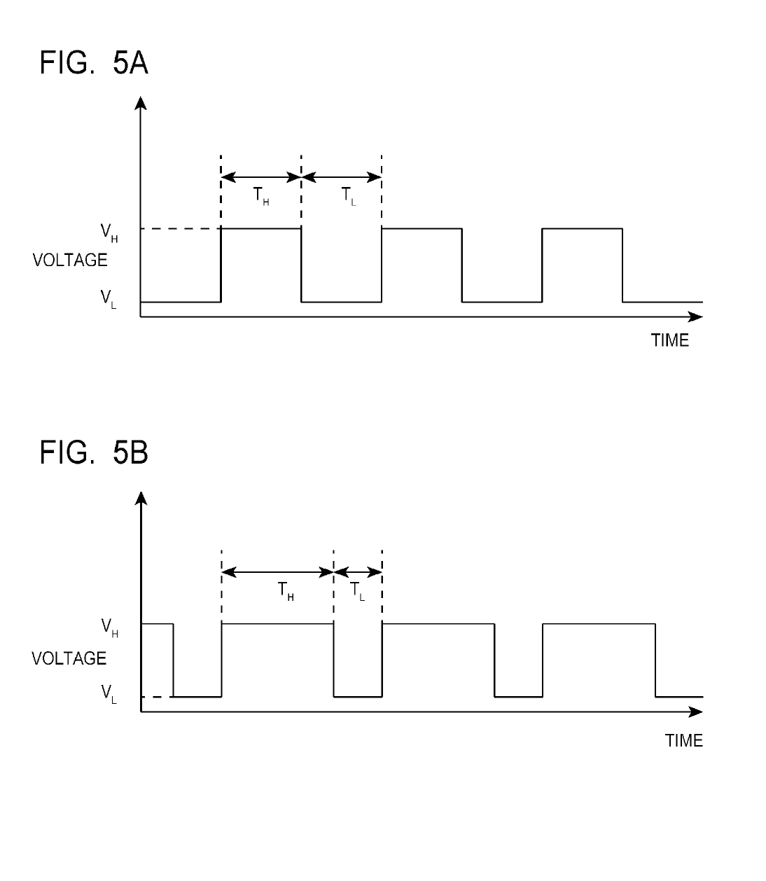

Here, PWM control is described. FIG. 5A illustrates an example of a PWM signal used in the PWM control. The PWM signal is a pulse signal that repeats a high voltage V_{H} and a low voltage V_{L}. A duty ratio (D=T_{H}/(T_{H}+T_{L})) is a parameter to determine electric power to be applied, where T_{H} denotes a time period when the high voltage state is maintained, and T_{L} denotes a time period when the low voltage state is maintained. For example, here assume that the electric power is applied to a load when the PWM signal is at the high voltage V_{H}. In this case, if the duty ratio of the PWM signal is increased as illustrated in FIG. 5B, the ratio of the time period for electric power application is increased and resultantly the electric power applied to the load is increased. In other words, even without changing the voltage value, the duty ratio may be changed to adjust the ratio of the time period for power supply, and thereby the electric power to be supplied can be changed continuously. Since the output of the CPU is a digital signal, to adjust ON/OFF of the pulse signal is easier than to continuously change the voltage. For this reason, the PWM control is used for purposes such as electric power control of a motor that needs rotational speed control.

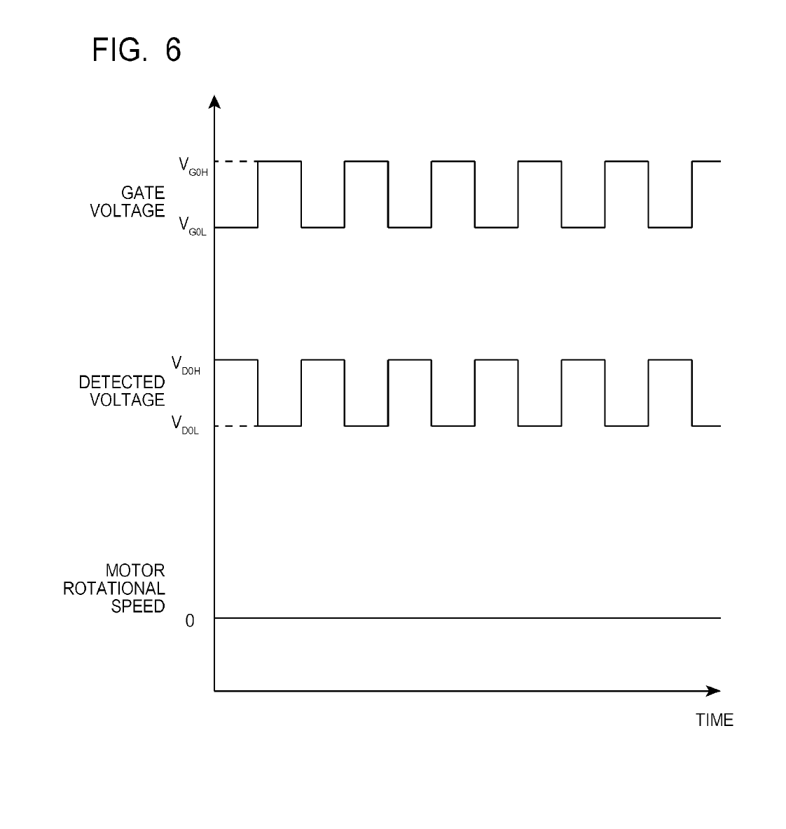

Here, operations of the driver circuit 400 are described. FIG. 6 is a diagram presenting temporal changes of a voltage at a gate terminal 402b of the FET 402 (gate voltage), a voltage applied to the voltage signal input unit 206 (detected voltage), and a rotational speed of the open-close motor 102c (motor rotational speed). As described above, the electric power applied to the open-close motor 102c is under the PWM control by the ECU 200 and the motor control signal output unit 208. The PWM signal outputted from the motor control signal output unit 208 is amplified by the pre-driver circuit 401, and the amplified signal is applied to the gate terminal 402b. The PWM signal is a pulse signal that alternately repeats a high voltage and a low voltage at a predetermined duty ratio and cycle. Accordingly, as presented on the upper side in FIG. 6, the gate voltage forms a pulse wave that alternately repeats voltages V_{G0H} and V_{G0L}. In the present embodiment, since the FET 402 is of the n-channel type, a larger amount of current flows from the drain terminal 402a to the source terminal 402c when the gate voltage is V_{G0H} than when the gate voltage is V_{G0L}. Thus, the voltage at the drain terminal 402a (drain voltage) becomes a low voltage at a time when the gate voltage becomes V_{G0H}, and becomes a high voltage at a time when the gate voltage becomes V_{G0L}. In this way, the pulse voltage generated under the PWM control is supplied to the open-close motor 102c connected to the drain terminal 402a via the wire 433.

At this time, the divided voltage of the drain voltage obtained by the voltage divider circuit 306 is applied to the voltage signal input unit 206. Since the gate voltage and the drain voltage of the FET 402 are inverted from each other as described above, the detected voltage forms a waveform inverted to that of the gate voltage (waveform shifted by half cycle) as presented on the center side of FIG. 5.

With the cycle of the PWM signal set to be sufficiently shorter than a time constant of the open-close motor 102c, the rotational speed of the open-close motor 102c can be stabilized. In this case, the motor rotational speed may not fluctuate due to cyclic changes in the voltage. In short, as presented on the lower side of FIG. 6, the motor rotational speed takes a constant value.

As described above, the driver circuit 400 includes the multiple wires. These wires are disposed in an environment, such as a back side of the slide door 101 of the vehicle 100, to which large stress is applied by a temperature change, vibration, humidity, load, and the like. For this reason, a short circuit may occur between wires due to causes such as a deterioration of the insulating coating on the wires, separation of the connect portions of the wires, and breaks of the wires. In addition, due to the same causes, a short circuit may also occur between any of the wires and the vehicle body 100a or the like having the ground potential. Here, description is provided for the detected voltage and an operation of the open-close motor 102c in each of cases where the wires 403, 413, 432, 433 are short-circuited to either of the wire having a power supply potential and the ground due to such a cause. Hereinafter, a short circuit to the wire or the like having the power supply potential is referred to as “short circuit to power supply” and a short circuit to a ground wire or a member such as a vehicle body 100a that functions as the ground is referred to as “short circuit to ground”. Here, in an initial state, the open-close motor 102c is stopped, and the slide door 101 is also stopped in the open state or the close state. When an electric current flows from the wire 413 to the wire 433, the open-close motor 102 rotates and the slide door 101 performs the open operation or the close operation. Since the open-close motor 102c includes a diode (not illustrated) for prevention of a counter electromotive force, the motor does not rotate reversely even if the electric current flows reversely due to a short circuit.

### <Circuit Operation in Case of Short Circuit of Wire 413 to Power Supply (Short Circuit Case 1)>

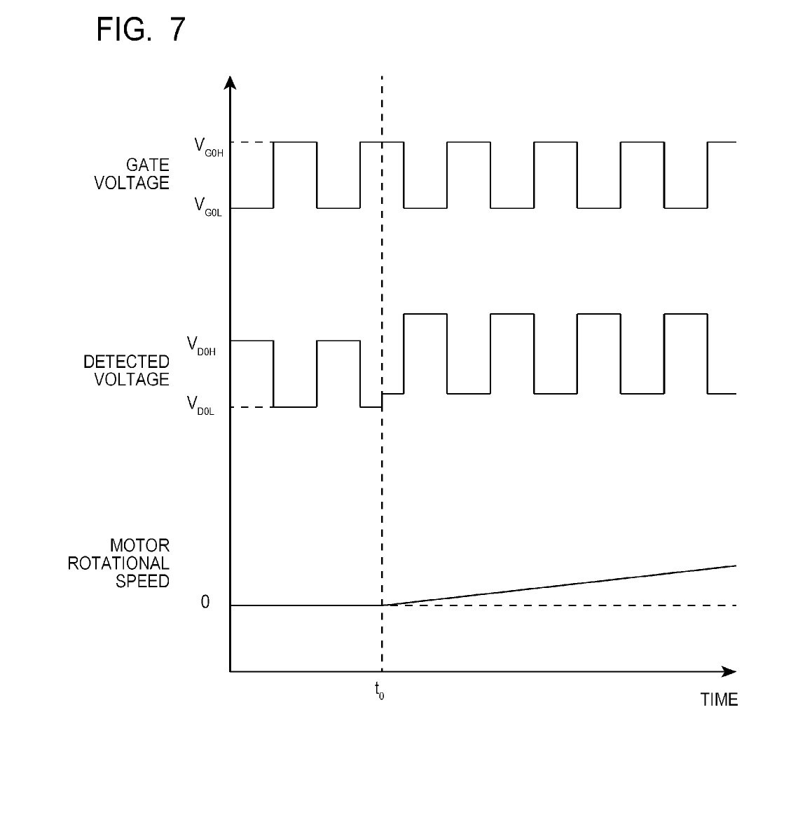

FIG. 7 presents temporal changes of the gate voltage, the detected voltage, and the motor rotational speed in the case where the wire 413 is short-circuited to the power supply at a time t₀. When the short circuit occurs, the wire 413 comes to have the same potential as the power supply source, a voltage drop by the resistor 412 becomes ineffective, and accordingly the voltage applied to the open-close motor 102c increases. Consequently, as presented on the lower side of FIG. 6, the motor rotational speed gradually increases as compared with the speed before the occurrence of the short circuit. This causes the slide door 101 to malfunction and perform the open operation or the close operation. Meanwhile, due to the increase in the voltage at the wire 413, the detected voltage also increases while maintaining the pulse waveform according to the PWM control as presented on the center side of FIG. 6.

### <Circuit Operation in Case of Short Circuit of Wire 413 to Ground (Short Circuit Case 2)>

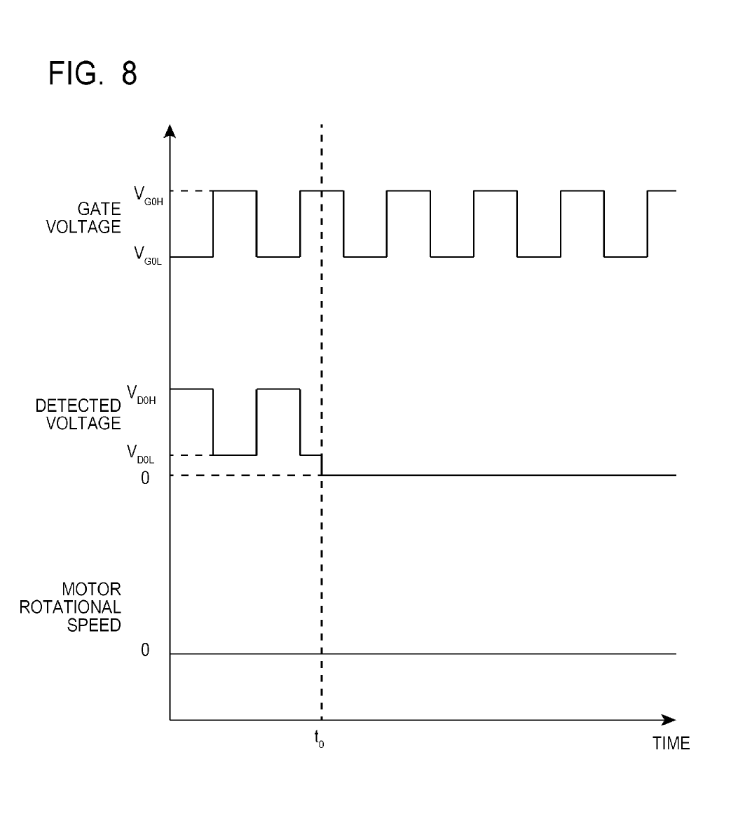

FIG. 8 presents temporal changes of the gate voltage, the detected voltage, and the motor rotational speed in the case where the wire 413 is short-circuited to the ground at a time t₀. When the short circuit occurs, the wire 413 comes to have the ground potential (0 V), and no voltage is applied to the open-close motor 102c. Consequently, as presented on the lower side of FIG. 8, the motor rotational speed is kept at 0, and the slide door 101 does not malfunction. Meanwhile, without supply of the voltage, the detected voltage becomes 0 as presented on the center side of FIG. 8.

### <Circuit Operation in Case of Short Circuit of Wire 433 to Power Supply (Short Circuit Case 3)>

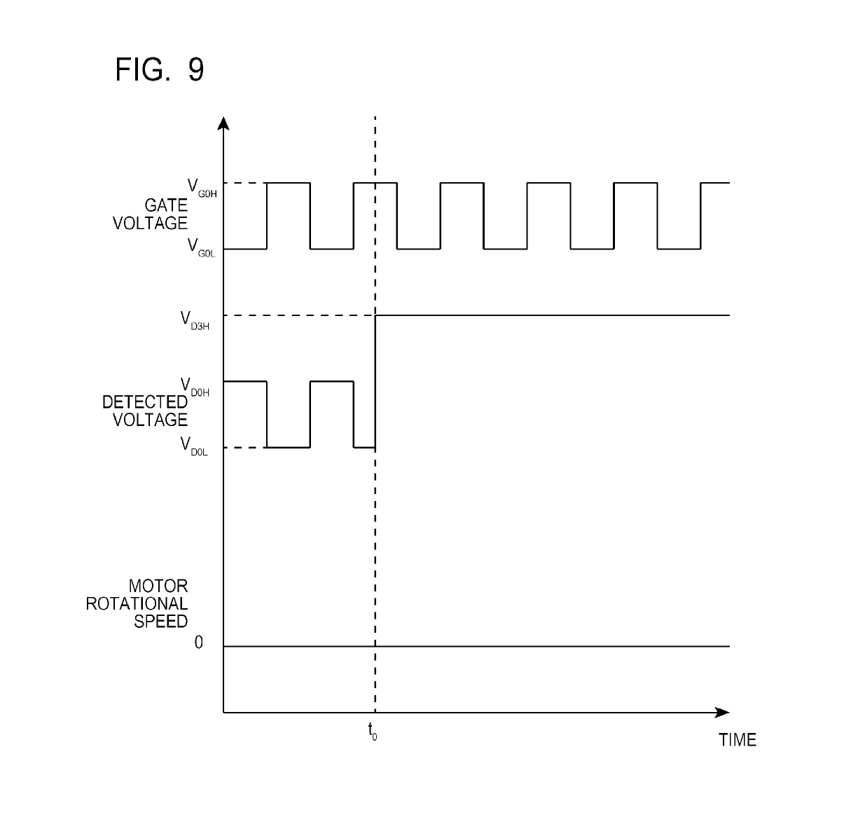

FIG. 9 presents temporal changes of the gate voltage, the detected voltage, and the motor rotational speed in the case where the wire 433 is short-circuited to the power supply at a time t₀. When the short circuit occurs, the power supply voltage is applied to both of the two terminals of the open-close motor 102c. In other words, the potential difference between the two terminals of the open-close motor 102c is 0. Consequently, as presented on the lower side of FIG. 9, the motor rotational speed is kept at 0, and the slide door 101 does not malfunction. Meanwhile, with the power supply voltage directly supplied to the wire 433, the detected voltage takes a constant value (V_{D3II}) in a high voltage state, and no pulses according to the PWM signal are detected.

### <Circuit Operation in Case of Short Circuit of Wire 433 to Ground (Short Circuit Case 4)>

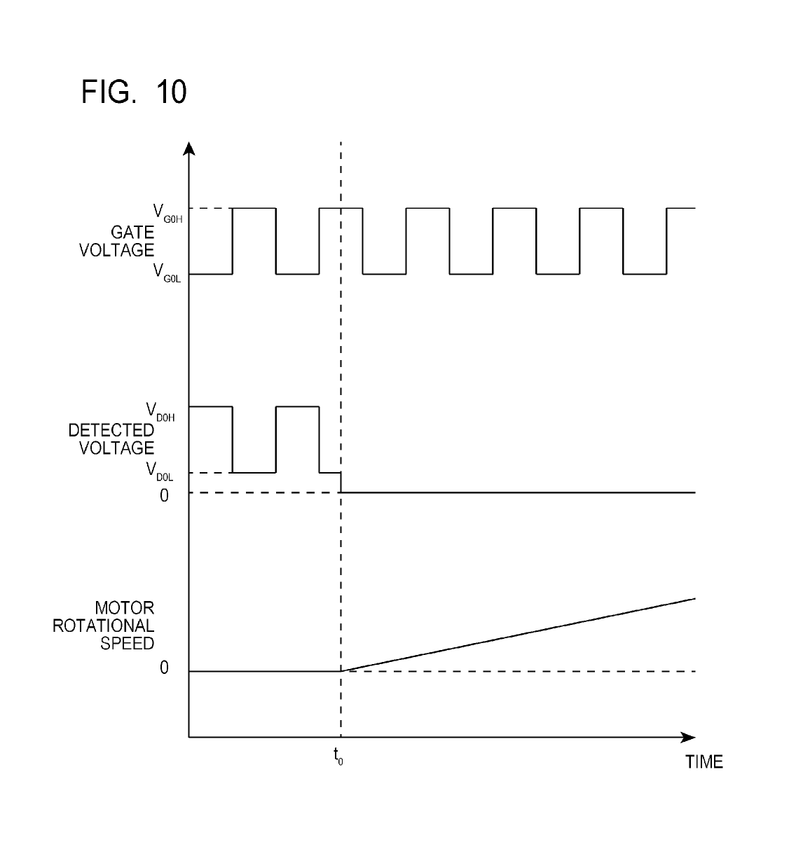

FIG. 10 presents temporal changes of the gate voltage, the detected voltage, and the motor rotational speed in the case where the wire 413 is short-circuited to the ground at a time t₀. When the short circuit occurs, the wire 433 comes to have the ground potential (0 V), and the potential difference between the two terminals of the open-close motor 102c increases. Consequently, as presented on the lower side of FIG. 10, the motor rotational speed gradually increases as compared with the speed before the occurrence of the short circuit. This causes the slide door 101 to malfunction and perform the open operation or the close operation. Meanwhile, the voltage at the wire 433 becomes 0, and the detected voltage also becomes 0 as presented on the center side of FIG. 10. Note that, in this case, the PWM control is not effective, and the electric power is always supplied to the open-close motor 102c. For this reason, the rotational speed of the open-close motor 102c increases more sharply and the slide door 101 performs the open operation or the close operation at a higher speed than in the short circuit case 1.

### <Circuit Operation in Case of Short Circuit of Wire 403 to Power Supply (Short Circuit Case 5)>

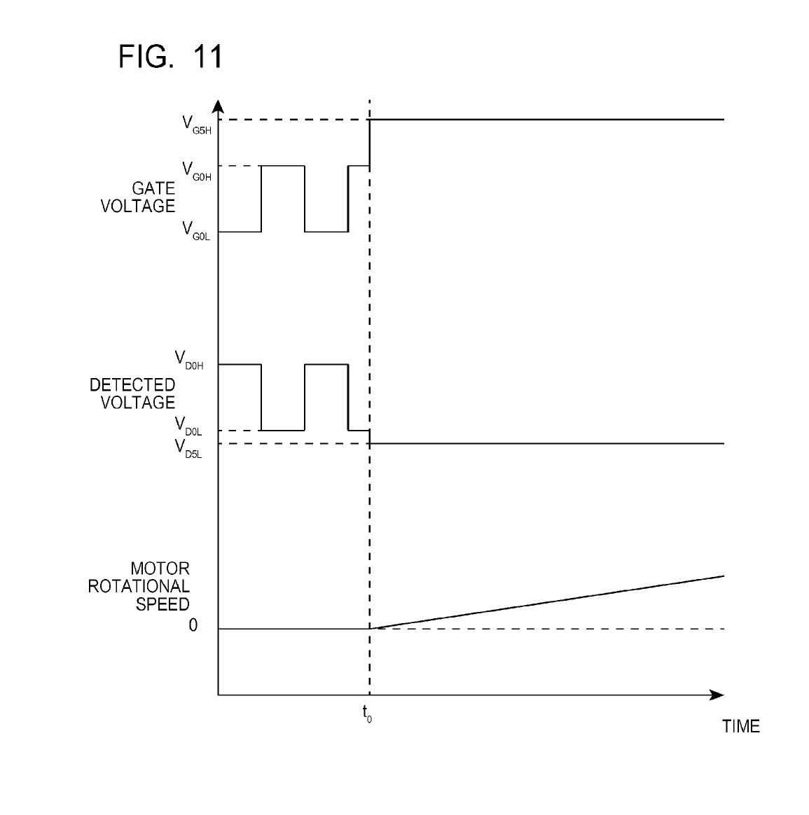

FIG. 11 presents temporal changes of the gate voltage, the detected voltage, and the motor rotational speed in the case where the wire 403 is short-circuited to the power supply at a time t₀. When the short circuit occurs, the wire 403 comes to have the same potential as the power supply source 431, and the gate voltage takes a constant value V_{G0H} that is higher than the voltage V_{G0H} on the high voltage side before the short circuit as presented on the upper side of FIG. 10. At this time, since the high voltage is continuously applied to the gate terminal 402b of the FET 402 all the time, the current continues flowing from the drain terminal 402a to the source terminal 402c, and a constant high voltage is always applied to the two terminals of the open-close motor 102c. Consequently, as presented on the lower side of FIG. 11, the motor rotational speed gradually increases as compared with the speed before the occurrence of the short circuit. This causes the slide door 101 to malfunction and perform the open operation or the close operation. Meanwhile, since the voltage at the wire 433 is kept at the low voltage, the detected voltage becomes a constant low voltage V_{D5L}, and no pulses according to the PWM signal are detected as presented on the center side of FIG. 11.

### <Circuit Operation in Case of Short Circuit of Wire 403 to Ground (Short Circuit Case 6)>

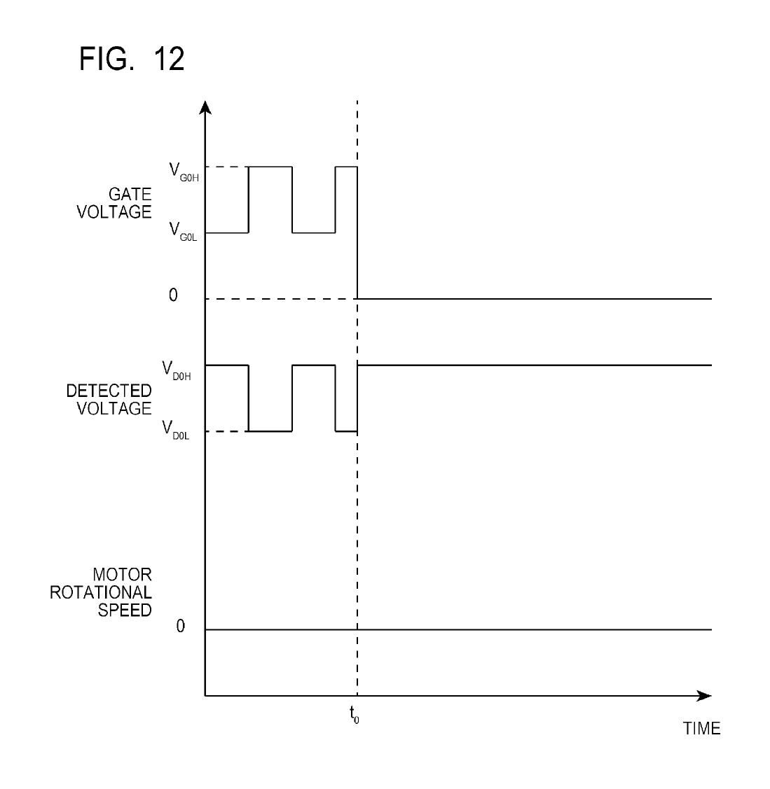

FIG. 12 presents temporal changes of the gate voltage, the detected voltage, and the motor rotational speed in the case where the wire 403 is short-circuited to the ground at a time t₀. When the short circuit occurs, the wire 403 comes to have the ground potential, and the gate voltage becomes 0 V as presented on the upper side of FIG. 12. At this time, the current does not flow from the drain terminal 402a to the source terminal 402c, and the voltage applied to the two terminals of the open-close motor 102c becomes lower than that before the short circuit. Consequently, as presented on the lower side of FIG. 12, the motor rotational speed is kept at 0, and the slide door 101 does not malfunction. Meanwhile, the detected voltage becomes constant at the high voltage V_{D0H}, and no pulses according to the PWM signal are detected as presented on the center side of FIG. 11.

### <Circuit Operation in Case of Short Circuit of Wire 432 to Power Supply (Short Circuit Case 7)>

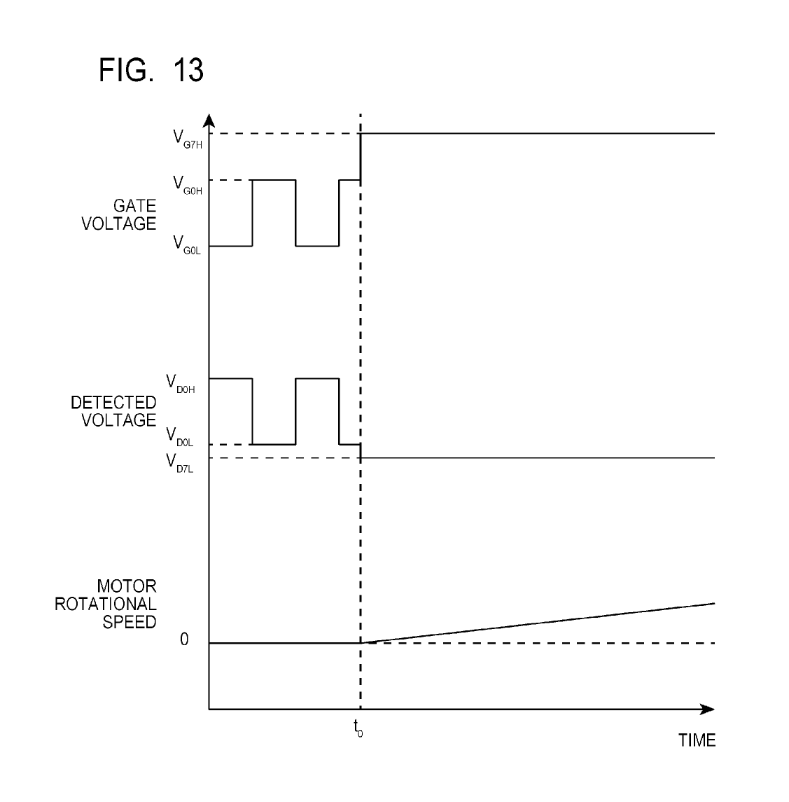

FIG. 13 presents temporal changes of the gate voltage, the detected voltage, and the motor rotational speed in the case where the wire 432 is short-circuited to the power supply at a time t₀. When the short circuit occurs, the wire 432 comes to have the same potential as the power supply source 431, and the power supply voltage is applied to the pre-driver circuit 401. In other words, the output of the pre-driver circuit takes a constant value of a voltage higher than that before the short circuit. Thus, the gate voltage takes a constant value of a voltage V_{G/H} that is higher than the voltage V_{G0H} on the high voltage side before the short circuit as presented on the upper side of FIG. 13. At this time, since the high voltage is always applied to the gate of the FET 402, the current continues flowing from the drain terminal 402a to the source terminal 402c, and a high voltage is always applied to the two terminals of the open-close motor 102c. Consequently, as presented on the lower side of FIG. 13, the motor rotational speed gradually increases as compared with the speed before the occurrence of the short circuit. This causes the slide door 101 to malfunction and perform the open operation or the close operation. Meanwhile, with the voltage at the wire 433 kept at the low voltage, the detected voltage becomes constant at a low voltage V_{D5L}, and no pulses according to the PWM signal are detected as presented on the center side of FIG. 13.

### <Circuit Operation in Case of Short Circuit of Wire 432 to Ground (Short Circuit Case 8)>

In the case where the wire 403 is short-circuited to the ground, the same phenomena as in the short circuit case 6 occur. Specifically, in this case, the temporal changes in the gate voltage, the detected voltage, and the motor rotational speed are the same as in FIG. 12. Accordingly, as presented on the lower side of FIG. 12, the motor rotational speed is kept at 0, and the slide door 101 does not malfunction.

### <Method of Detecting Short Circuit and Method of Preventing Malfunction of Open-Close Member>

The following description is provided for the detected voltage at the input terminal 201b and the operation of the open-close motor 102c in each of the short circuit cases 1 to 8 where the wires 403, 431, 432, and 433 are short-circuited to either of the power supply source 431 and the ground. A summary of them is listed in the following table.

TABLE 1

| Short | Short Circuit | | | Motor | Malfunction | |
|---|---|---|---|---|---|---|
| Circuit | (SC) Occurrence | Gate | Detected | Rotational | of Slide | PWM |
| Case | State | voltage | Voltage | Speed | Door | Control |
| Normal | No SC | No | No | No | No | Effective |
| State | | Change | Change | change | Malfunction | |
| 1 | SC of Wire 431 | No | UP | Up | Malfunction | Effective |
| | to Power Supply | Change | (Pulse | | | |
| | | | Waveform) | | | |
| 2 | SC of Wire 431 | No | Zero | No | No | Ineffective |
| | to Ground | Change | (Constant | change | Malfunction | |
| | | | Value) | | | |
| 3 | SC of Wire 433 | No | Up | No | No | Ineffective |
| | to Power Supply | Change | (Constant | change | Malfunction | |
| | | | Value) | | | |
| 4 | SC of Wire 433 | No | Zero | Up | Malfunction | Ineffective |
| | to Ground | Change | (Constant | | | |
| | | | Value) | | | |
| 5 | SC of Wire 403 | Up | Down | Up | Malfunction | Ineffective |
| | to Power Supply | (Constant | (Constant | | | |
| | | Value) | Value) | | | |
| 6 | SC of Wire 403 | Zero | High Voltage | No | No | Ineffective |
| | to Ground | | (Constant | change | Malfunction | |
| | | | Value) | | | |
| 7 | SC of Wire 432 | Up | Down | Up | Malfunction | Ineffective |
| | to Power Supply | | (Constant | | | |
| | | | Value) | | | |
| 8 | SC of Wire 432 | Zero | High | No | No | Ineffective |
| | to Ground | | Voltage | change | Malfunction | |
| | | | (Constant | | | |
| | | | Value) | | | |

Table 1 presents a short circuit occurrence state, a change in the gate voltage, a change in the detected voltage, a change in the motor rotational speed, and the effectiveness of PWM control after a short circuit in each of the short circuit cases. In the short circuit cases 1, 4, 5, and 7 where the motor rotational speed increases, the slide door 101 malfunctions and performs the open operation or the close operation. This means that it is not sufficient to simply detect a short circuit, but is also necessary to perform control to prevent a malfunction of the slide door 101 based on a detection result. In addition, in the short circuit cases 4, 5, and 7, the PWM control cannot be used to control for slowing down or stopping the slide door 101.

Here, description is provided for a method of detecting the short circuit cases 1, 4, 5, and 7 based on the detected voltage. As presented in Table 1, the detected voltage increases in the short circuit case 1, the detected voltage becomes zero in the short circuit case 4, and the detected voltage decreases in the short circuit cases 5 and 7. Meanwhile, in the short circuit cases 4, 5, and 7, the detected voltage takes a constant value, in other words, the waveform according to the PWM signal is not detected. In summary, if the detected voltage is detected increasing and maintaining the PWM signal waveform, it can be inferred that there is a possibility of the occurrence of the short circuit case 1. In contrast, if the detected voltage is detected decreasing and losing the PWM signal waveform, it can be inferred that there is a possibility of the occurrence of any of the short circuit cases 4, 5, and 7. Here, the measured voltage is a pulse voltage in the normal state or in the short circuit case 1. Voltage information used as a criterion for judging these cases may be at least one selected from voltages such as the voltage V_{H} on the high voltage side, the voltage V_{L} on the low voltage side, a simple average voltage ((V_{H}+V_{L})/2) of these voltages, and a weighted average voltage (DV_{H}+(1−D)V_{L}) of these voltages with the duty ratio D. Such quantification of the voltage information by a numeric value (or numeric values) enables a clear judgement on whether the detected voltage is within a predetermined range. Among them, it is particularly desirable to use the weighted average voltage with the duty ratio D. The weighted average voltage with the duty ratio D is a parameter correlated well to the electric power to be supplied to the open-close motor 102c. Thus, by using the weighted average voltage with the duty ratio D, a threshold for detecting a short circuit can be set such that satisfactory detection accuracy can be attained.

Here, description is provided for the control for slowing down or stopping the slide door 101 in each of the cases.

When any one of the short circuit cases 1, 4, 5, and 7 is detected, the shut-off signal output unit 209 of the ECU 200 transmits a control signal, and thereby the switch 304 is operated and closed. As a result, the application of the voltage to the motor is stopped, and thus the slide door 101 can be slowed down or stopped. In the short circuit case 1, both the shut-off of the power supply source by the switch 304 and the PWM control are usable. Thus, the slide door 101 can be slowed down or stopped not only by performing the aforementioned shut-off of the power supply source, but also by decreasing the motor rotational speed through adjustment of the duty ratio of the PWM signal outputted from the motor control signal output unit 208 of the ECU 200. In this case, the power supply source is not shut off, which brings an advantage in that the operations of the electrically-driven devices other than the control device of the motor are not affected.

### <Control Method of Vehicle Open-Close Member>

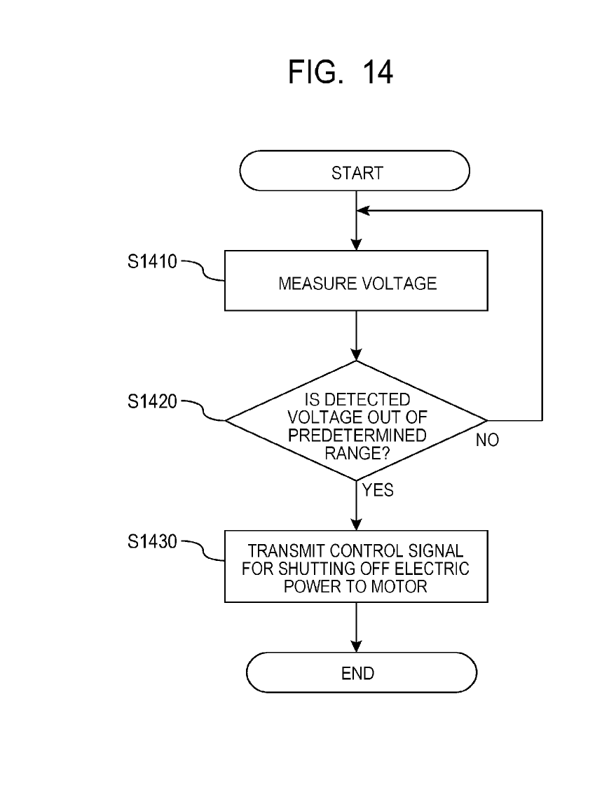

FIG. 14 presents a flowchart of a control method of detecting any of the aforementioned short circuit cases 1, 4, 5, and 7 and preventing a malfunction of the slide door 101.

In step S1410, the ECU 200 measures the voltage inputted to the voltage signal input unit 206. In the normal state, the signal applied to the FET 402 is the PWM signal, and therefore the voltage measured is also a pulse voltage that repeats the high voltage and the low voltage. For this reason, the ECU 200 may detect not only the voltage value, but also whether the measured voltage is a pulse voltage or not, and may refer to the thus-obtained information in the following steps.

In step S1420, the ECU 200 judges the short circuit state by means of the short-circuit state judgement unit 204 based on the voltage measured in step S1410. If the detected voltage increases or decreases beyond a predetermined range, the ECU 200 judges that there is a possibility of the occurrence of at least one of the aforementioned short circuit cases 1, 4, 5, and 7, and advances to step S1430. If not, the ECU 200 returns to step S1410 and continues measuring the voltage.

In step S1430, the ECU 200 transmits a control signal from the shut-off signal output unit 209, the control signal being for shutting off electric power to be supplied to the motor by making the switch 304 open. The shut-off of the electric power to be supplied to the open-close motor 102c can prevent the slide door 101 from malfunctioning.

The control device for the vehicle open-close member according to the present embodiment is capable of judging a short circuit in the circuit for controlling the open-close motor, and stopping the vehicle open-close member from malfunctioning when detecting that the circuit is in the short-circuited state where the circuit may possibly cause a malfunction. This makes it possible to prevent a malfunction in which the door is opened despite the intention of a user while the vehicle is running or is stopped, and a malfunction in which the door in the open state is closed despite the intention of a user.

### <Modification of Control Flow>

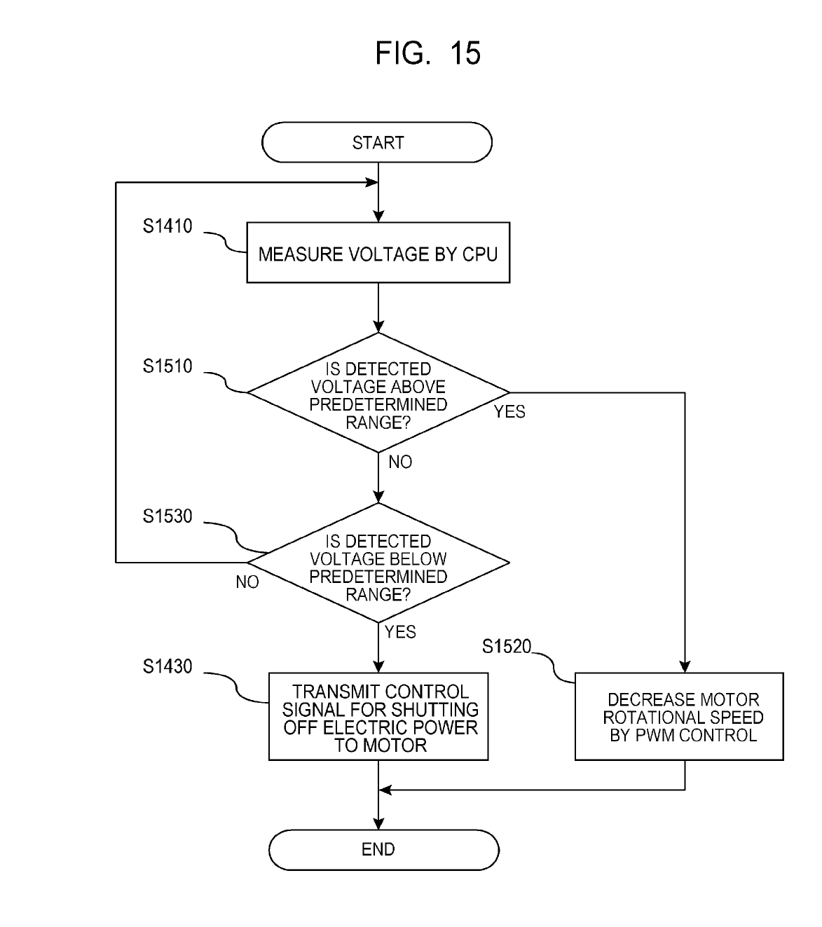

FIG. 15 presents a flowchart of a control method according to a modification. This modification is characterized in that the control method further includes a step of performing control with the PWM control, instead of step S1430, in the case of detecting the occurrence of the short circuit case 1 where the PWM control is effective. Steps S1410 and S1430 are almost the same as those in the foregoing flow, and are omitted from the explanation below.

In step S1510, the ECU 200 judges the short circuit state by means of the short-circuit state judgement unit 204 based on the voltage measured in step S1410. If the detected voltage increases to above a predetermined range, the ECU 200 judges that there is a possibility of the occurrence of the short circuit case 1, and advances to step S1520. If not, the ECU 200 advances to step S1530.

In step S1420, the ECU 200 judges the short circuit state by means of the short-circuit state judgement unit 204 based on the voltage measured in step S1410. If the detected voltage decreases to below the predetermined range, the ECU 200 judges that there is a possibility of the occurrence of at least one of the short circuit cases 4, 5, and 7, and advances to step S1430. If not, the ECU 200 returns to step S1410 and continues measuring the voltage.

In step S1520, the ECU 200 transmits a control signal from the motor control signal output unit 208, the control signal being for adjusting a parameter such as the duty ratio of the PWM signal. Thus, the electric power to be supplied to the open-close motor 102c is controlled at a predetermined value, whereby the slide door 101 can be prevented from malfunctioning.

The control device for the vehicle open-close member according to this modification is capable of stopping a malfunction of the vehicle open-close member, by performing the PWM control, instead of shutting off the electric power, if the control device judges that the short circuit case 1 in which the PWM control is effective occurs in the circuit for controlling the open-close motor. Thus, in the short circuit case 1, the electric power is not shut off, and the supply of electric power to the other electrically-driven systems inside the vehicle is not blocked.

In step S1520, step S1430 may be also performed in combination. In this case, the vehicle open-close member can be more reliably stopped from malfunctioning

In addition, the control method may further include a step of storing information indicating a short circuit case into the memory 102 after step S1520 or S1430. In this case, a maintenance worker can acquire the information on a short circuit location, and therefore can efficiently repair the short circuit location.

This application claims the benefit of priority from Japanese Patent Application No. 2013-224066 filed on Oct. 29, 2013, the contents of which are incorporated by reference as part of the description of this application.

### EXPLANATION OF THE REFERENCE NUMERALS

100 vehicle
102 open-close driver device
102c open-close motor
200 ECU
204 short-circuit state judgement unit
205 input circuit
206 voltage signal input unit
207 output circuit
208 motor control signal output unit
209 shut-off signal output unit
304 switch
305 power supply source

1. A control device for a vehicle open-close member comprising:
an input circuit configured to receive an inputted voltage signal indicating a drive voltage, a power supply voltage and the drive voltage being respectively applied to one terminal and another terminal of an open-close motor of a vehicle open-close member;
a short-circuit state judgement unit configured to judge a short circuit as occurring when the drive voltage is out of a predetermined range; and
an output circuit configured to output a control signal for decreasing a voltage to be applied to the open-close motor, when the short circuit is judged as occurring.

2. The control device for a vehicle open-close member according to claim 1, wherein the control signal is for decreasing the voltage to be applied to the open-close motor by shutting off application of the power supply voltage to the open-close motor.

3. The control device for a vehicle open-close member according to claim 1, wherein
in judging whether the drive voltage is out of the predetermined range, the short-circuit state judgement unit further judges whether the drive voltage is above the predetermined range or below the predetermined range, and
the output circuit outputs control signals different between cases where the drive voltage is judged as above the predetermined range and where the drive voltage is judged as below the predetermined range.

4. The control device for a vehicle open-close member according to claim 3, wherein
the output circuit further includes a motor control signal output unit and a shut-off signal output unit,
when the drive voltage is above the predetermined range, the motor control signal output unit outputs a first control signal for decreasing the voltage to be applied to the open-close motor by changing the drive voltage, and
when the drive voltage is below the predetermined range, the shut-off signal output unit outputs a second control signal for decreasing the voltage to be applied to the open-close motor by shutting off application of the power supply voltage.

5. The control device for a vehicle open-close member according to claim 1, wherein
the drive voltage is a pulse voltage that varies cyclically, and
the short-circuit state judgement unit makes the judgement based on at least one of a voltage V_{H} on a high voltage side of the pulse voltage, a voltage V_{L} on a low voltage side of the pulse voltage, a simple average voltage ((V_{H}+V_{L})/2) of these voltages, and a weighted average voltage (DV_{H}−(1−D)V_{L}) of these voltages with a duty ratio D.

6. A control method for a vehicle open-close member, comprising:
inputting a voltage signal indicating a drive voltage, a power supply voltage and the drive voltage being respectively applied to one terminal and another terminal of an open-close motor of a vehicle open-close member;
judging a short circuit as occurring when the drive voltage is out of a predetermined range; and
outputting a control signal for decreasing a voltage to be applied to the open-close motor, when the short circuit is judged as occurring.

7. A vehicle open-close member comprising:
an open-close motor configured to drive the vehicle open-close member with application of electric power;
a control device configured to receive an inputted voltage signal indicating a drive voltage, a power supply voltage and the drive voltage respectively being applied to one terminal and another terminal of the open-close motor of the vehicle open-close member, and to output a control signal for decreasing a voltage to be applied to the open-close motor, when the drive voltage is out of a predetermined range; and
a switch configured to shut off supply of electric power to be applied to the open-close motor when the control signal is inputted to the switch.
